(19) United States
(12) Patent Application Publication
(10) Pub. No.: US 2012/0301841 A1
(43) Pub. Date: Nov. 29, 2012

(54) HANDPIECE COMPRISING A BODY INCLUDING A HOLLOW SLEEVE

(75) Inventors: Philippe Garcia, Bussieres (FR); Laurent Clerget, Byans Sur Le Doubs (FR)

(73) Assignee: MICRO MEGA INTERNATIONAL MANUFACTURES, BESANCON (FR)

(21) Appl. No.: 13/513,776

(22) PCT Filed: Dec. 6, 2010
(86) PCT No.: PCT/FR10/52621

§ 371 Date: Aug. 11, 2012

(30) Foreign Application Priority Data
Dec. 4, 2009 (FR) 0905915
Feb. 18, 2010 (FR) 1051176

(51) Int. Cl. A61C 3/00

(52) U.S. Cl. 433/29

(57) ABSTRACT

A handpiece includes a head for receiving a tool, a rear sleeve for coupling the handpiece to a motor, and a body connecting the head to the rear sleeve. The body includes a hollow sleeve in which mechanical members are mounted in order to transmit a rotating movement to the tool. The body also includes an over-molded casing made from a composite material, in which the hollow sleeve is encased. The handpiece is suitable for use in the dental and medical fields.

### TECHNICAL FIELD AND PRIOR ART

The invention relates to a handpiece comprising a head intended to receive a tool, a rear sleeve intended for coupling the handpiece to a motor and a body connecting the head to the rear sleeve, the body comprising a hollow sleeve inside which mechanical members for transmitting a rotational movement, to the tool are mounted. The invention can he used in particular in the dental or medical sector.

Handpieces or contra-angles are used by dentists for rotationally driving tools intended for milling teeth or more generally for carrying out the different operations which the dentist must perform.

Handpieces are precision instruments and must allow the dentist to perform precision work in the best possible conditions, in particular with regard to visibility and comfort. The gripping zone of the handpiece is therefore, very important for providing the dentist with tactile precision and gripping comfort.

The handpieces are also often provided with means for cooling the working zone of the tool, designed to convey a fluid, conventionally water or compressed air, into the vicinity of the tool, in order to cool the tool and the tooth treated while working with the tool. Handpieces are also often equipped with means for lighting the working zone, conventionally a light conductor which transmits the light from the rear sleeve of the handpiece to the working zone of the tool.

It is generally known to position the fluid conveying tubes and/or the light conductors inside usually metallic sleeves which surround the tubes and the light conductor around the hollow sleeve, but it is fairly difficult managing to house all these parts together with the mechanical drive members inside the hollow sleeve. EP 0,682,921 also discloses a ha loon in which a tube outside the hollow sleeve allows conveying of a cleaning fluid such as water in the region of the head of the handpiece, i.e. in the region of the one to be treated. However, such an external tube hinders gripping of the handpiece.

Moreover, it is important to be able to clean easily the handpieces in order to prevent any contamination of the patient. These known handpieces are often made as several assembled parts with interstices which are difficult to access and inside which contaminating agents such as bacteria may be harbored.

Finally, the hollow sleeve forming the body of the current handpieces is usually machined. Machining of the outer surface of the hollow sleeve is difficult and must be performed in a particularly precise, manner because the outer surface of the sleeve is in direct contact with the dentist's hands. Moreover, with a machining process it is possible, to produce only sleeves with an external surface which has a circular symmetry in relation to their longitudinal axis. Such a form is not optimized to match the form of the dentist's hand. Consequently use of the handpiece requires adaptation on the part of the dentist.

### DESCRIPTION OF THE INVENTION

The invention proposes a novel handpiece which does not have at least some of the drawbacks of the known handpieces described above.

More precisely, the invention proposes a handpiece otherwise corresponding to the known handpieces described above and characterized in that the body of the handpiece also comprises an overmolded composite-material casing inside which casing the hollow sleeve is embedded.

The hollow sleeve is generally a machined metal part. In the context of the invention, the outer casing is overmolded onto the hollow sleeve and the sleeve is embedded inside the overmolded casing. The external form of the handpiece is thus the external form of the casing and no longer the external form of the hollow sleeve. Manufacture of the hollow sleeve is made easier since it is no longer required to refine its external form: during machining since the hollow sleeve is entirely covered by the casing. Moreover, the use of a composite material for manufacture of the casing facilitates molding thereof and formation of its external surface which must be performed with particular precision. Thus, the form and the external surface of the outer casing may be optimized in an easy and low-cost manner so as to be adapted in the best possible manner to the form of the dentist's hand. It is thus possible to envisage easily a specific form and surface for right-handed dentists or left-handed dentists, for example. Finally, the body of the handpiece consists of a single piece and no longer has recesses which may harbor bacteria and are difficult to clean.

The body of the handpiece may be straight or angled, depending on the use which is envisaged,

The body may also comprise at least one tube intended to convey a fluid from the rear sleeve to the head and/or at least one light conductor intended to convey the light from the rear sleeve to the head, In this case, the at feast one tube and/or at least one light conductor is (are) embedded together with the hollow sleeve inside the casing. Thus, the overmolded casing positions and keeps in place the hollow sleeve, the fluid conveying tube or tubes and the light conductor or conductors in relation to each other. Moreover, no tube or light conductor on the outside of the casing hinders gripping of the handpiece.

Preferably, the hardness of the composite material is adjusted so as to optimize the gripping comfort of the handpiece. It is thus possible to produce, casings made of material which is harder or softer, depending on the preferences of the users or the use which is envisaged for the handpiece. Also preferably the external form of the casing is adjusted to optimize the gripping comfort of the handpiece. The fact that he casing is overmolded and not machined facilitates its manufacture and optimization: of its external form.

The composite material is for example PEEK (polyether ether ketone), a thermostable plastic, or silicone, These two materials have the advantage that they are resistant to the cleaning products and the sterilization operations.

The color of the composite material may be chosen depending on predefined parameters of the handpiece, for example a rotational driving speed of the tool, a torque available on the tool and/or a type of predefined tool able to be mounted on the handpiece. For example, the color red for high speeds, the color blue for medium speeds and the color green for low speeds. By referring to the color, the dentist may therefore immediately determine whether a handpiece is suitable or not for a desired use.

The casing may be covered with an outer sleeve, for example made of metallic material. The outer sleeve has for example a small thickness or very small thickness. With such an outer sleeve the dentist may obtain the same feel with the handpiece according to the invention as with the handpieces of the prior art as regards most metals. Such a sleeve, is also able to provide a handpiece according to the invention with an aesthetic appearance which is different from that of a handpiece comprising only en external casing made of composite material.

### DESCRIPTION OF THE EMBODIMENT OF THE INVENTION SHOWN IN THE FIGURES

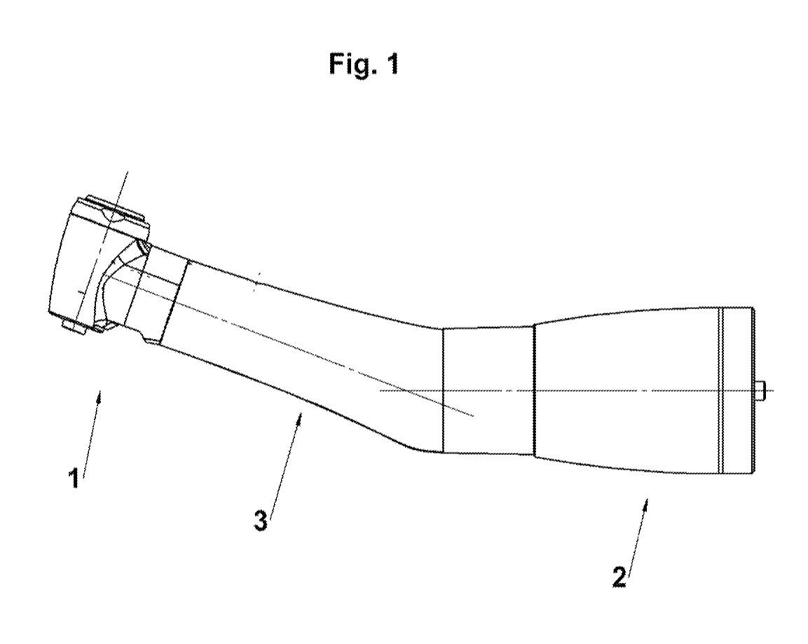

The invention will be understood more fully and other characteristic features and advantages of the invention will become clear in the light of the following description of an example of embodiment of a handpiece according to the invention. This example is provided by way of a non-limiting example. The description is to be read in connection with the accompanying drawings in which FIGS. 1 to 3 are respectively a front view, a cross-sectional view and an exploded view of a handpiece according to the invention.

The handpiece shown in the figures comprises a head 1 which is intended to receive a tool not shown) inside a shaft 6, a rear sleeve 2 intended for coupling the handpiece to a motor (not shown) and a body connecting the head 1 to the rear sleeve 2. The body 3 comprises:
a hollow sleeve 11 inside which mechanical members 4, 5 for transmitting a rotational movement to the tool are mounted;
two hollow tubes 8 intended to convey cooling fluids, for example water and air, from the rear sleeve 2 to the head 1; and
a Light conductor 9 intended to convey the light from the rear sleeve 2 to the head 1.

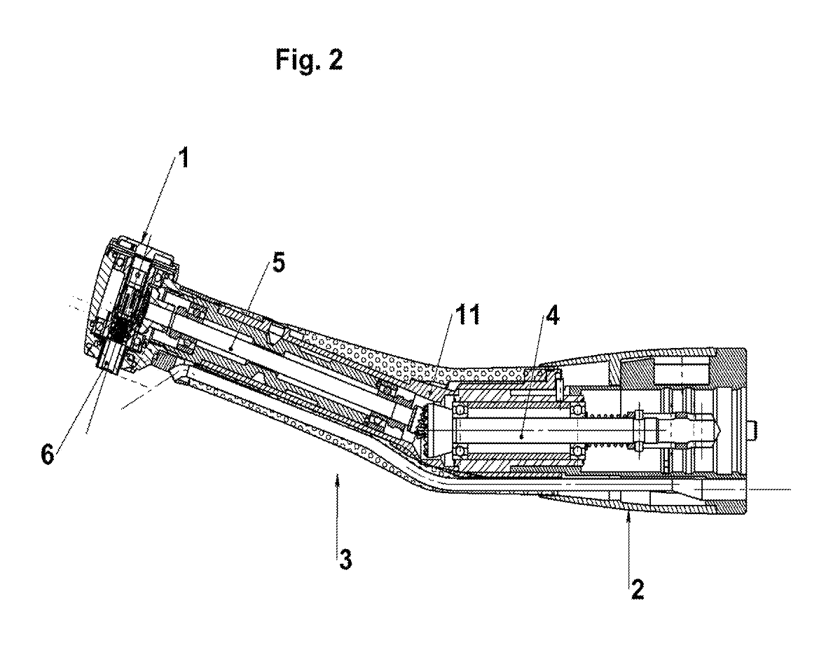

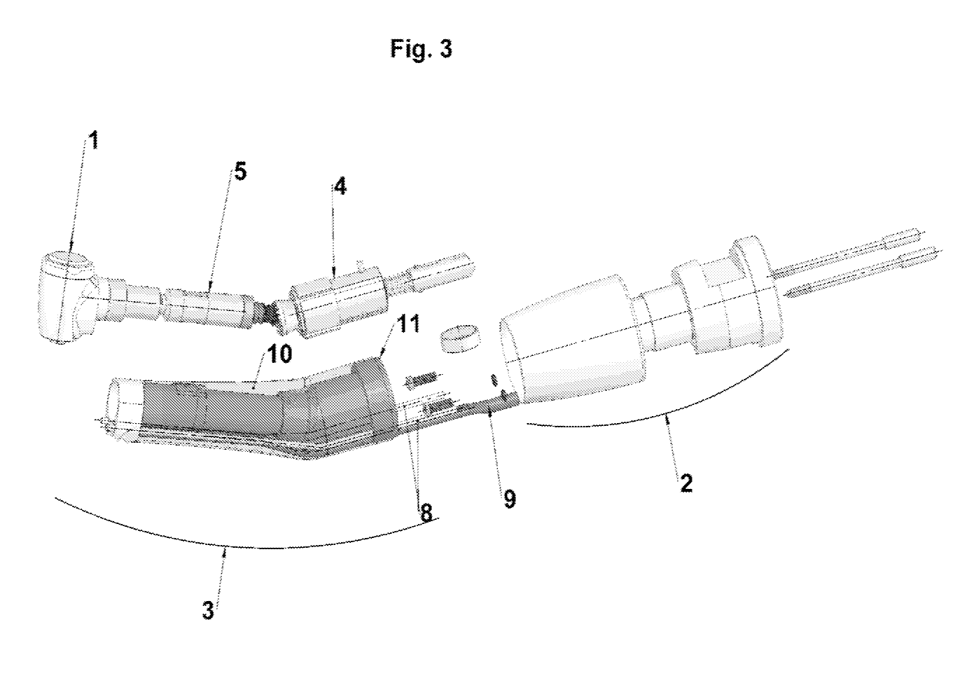

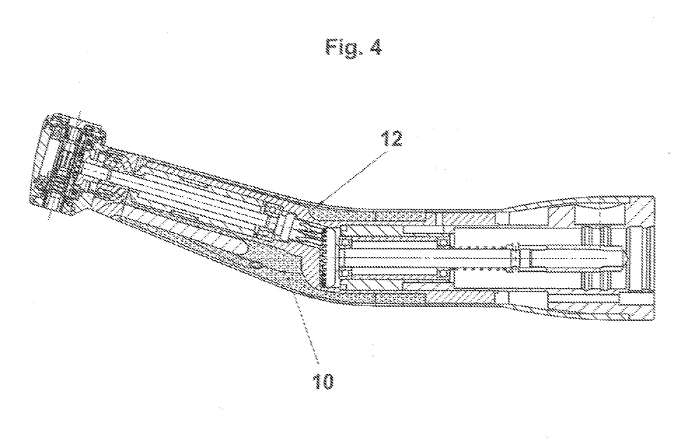

In the example shown, the hollow sleeve is metallic and has a general cylindrical shape or rather the shape of two cylinders combined to form an angled part (FIGS. 2 and 3). The external surface of the hollow sleeve does not have the usual comfort features and surface conditions of the hollow sleeves of known handpieces.

In the example shown also, the body 3 of the handpiece comprises an overmolded composite-material casing 10 inside which the hollow sleeve 2, the tubes 8 and the light conductor 9 are embedded. The casing covers entirely the hollow sleeve so that it is no longer necessary to manufacture the external surface of the hollow sleeve with particular precision. The casing forms an integral part of the handpiece and gives it its external shape. Since the casing is molded onto the hollow sleeve it is irremovable.

In the example shown, the casing 10 is shown in exploded form in FIG. 3. On the outside, the overmolded casing has substantially the form of a cone of variable conicity and has an angled part. The external surface is smooth, but a rougher surface may be envisaged in order to ensure better gripping of the handpiece. The internal surface casing is adjusted to the form of the hollow sleeve which it covers.

The thickness of the casing is variable along a longitudinal axis of the casing (FIGS. 2 and 3). It is dependent or the form of the external surface of the sleeve (chosen for easy machining thereof) and the external form of the casing (chosen to provide the dentist with maximum comfort).

The thickness of the casing may also be variable in a plane perpendicular to the longitudinal axis of tha casing so as to adapt in the hest possible manner to the form of the dentist's hand. It is also possible to envisage a specific form and surface for right-handed dentists and left-handed dentists, for example.

1. A handpiece comprising a head intended to receive a tool, a rear sleeve intended for coupling the handpiece to a motor and a body connecting the head to the rear sleeve, the body comprising a hollow sleeve inside which mechanical members for transmitting a rotational movement to the tool are mounted, the body comprising at least one tube intended to convey a fluid from the rear sleeve to the head and/or at least one light conductor intended to convey the light from the rear sleeve to the head,
the handpiece being characterized in that the body also comprises an overmolded composite-material casing inside which the at least one tube and/or the at least one light conductor is (are) embedded together with the hollow sleeve inside the overmolded casing which thus positions and keeps in place the hollow sleeve, the fluid conveying tube or tubes and/or the light conductor or conductors in relation to each other.

2. The handpiece as claimed in claim 1, wherein the hardness of the composite material is adjusted so as to optimize the gripping comfort of the handpiece.

3. The handpiece as claimed in claim 1, wherein the external form of the casing is adjusted so as to optimize the gripping comfort of the handpiece.

4. The handpiece as claimed in claim 1, wherein the color of the composite material is chosen depending on predefined parameters of the handpiece, for example a rotational driving speed of the tool, a torque available on the tool and/or a predefined tool type able to be mounted on the handpiece.

5. The handpiece as claimed in claim 1, wherein the body is straight or angled.

6. The handpiece as claimed in claim 1, wherein the composite material is PEEK or silicone.

7. The handpiece as claimed in claim 1, wherein the casing is covered with an outer sleeve, for example made of metallic material.
